(19) United States
(12) Patent Application Publication
(10) Pub. No.: US 2014/0359228 A1
(43) Pub. Date: Dec. 4, 2014

(54) CACHE ALLOCATION IN A COMPUTERIZED SYSTEM

(71) Applicant: International Business Machines Corporation, Armonk, NY (US)

(72) Inventors: Xiao-Yu Hu, Horgen (CH); Nikolas Ioannou, Zurich (CH); Ioannis Koltsidas, Zurich (CH); Roman A. Pletka, Uster (CH); Thomas D. Weigold, Thalwil (CH)

(73) Assignee: International Business Machines Corporation, Armonk, NY (US)

(21) Appl. No.: 14/253,962

(22) Filed: Apr. 16, 2014

(30) Foreign Application Priority Data
May 29, 2013 (GB) 1309555.9

(51) Int. Cl. G06F 12/08; G06F 12/12

(52) U.S. Cl. CPC G06F 12/0871; G06F 12/122
USPC 711/136

(57) ABSTRACT

A computerized system comprises a solid state memory and a controller adapted to use the solid state memory as a cache for the computerized system. The controller is adapted to add or to remove a chunk of data from the cache based on a detected frequency of occurrence of the chunk of data in the computerized system.

### CROSS REFERENCE TO RELATED APPLICATIONS

The present application claims the benefit of priority of United Kingdom Patent Application Serial Number 1309555.9, filed May 29, 2013, with the UK Intellectual Property Office (UKIPO), the contents of which are herein incorporated by reference in their entirety.

### FIELD OF THE INVENTION

The present invention relates to a method for operating a solid state memory as a cache in a computerized system, and to a computerized system.

### BACKGROUND

To accommodate the ever-increasing storage needs of users and applications, the capacity of storage systems is constantly growing. In light of this, the scalability of storage systems in terms of performance is critical not only for existing applications, but also for new types of applications that expect improved latency and throughput. Caching on DRAM memory has traditionally been one of the most straightforward ways of improving the performance of storage systems, both in terms of latency and throughput. By increasing the size of the DRAM cache as one adds more disks, one can maintain the same performance over capacity ratio. However, DRAM caches cannot scale in terms of size: Not only does DRAM memory require a lot of power even when it is idle, but also it is volatile by nature, meaning that it has to be backed by batteries to protect against power failures.

Various selective caching techniques are known for deciding which data to bring into the cache and which data to evict from the cache when a replacement operation is required. These techniques, however, rely on properties of the logical block addresses, such as frequency of accesses or recency of accesses or various combinations thereof.

### BRIEF SUMMARY

According to one aspect of the invention, a method is provided for operating a solid state memory as a cache in a computerized system. A chunk of data is added to the cache dependent on a detected frequency of occurrence of the chunk of data in said computerized system.

According to another aspect of the present invention, a method is provided for operating a solid state memory as a cache in a computerized system: A chunk of data from is removed from the cache dependent on a detected frequency of occurrence of the chunk of data in the computerized system.

Preferred embodiments of the methods contain one or more of the following features:
the chunk of data is added to the cache by updating a metadata structure for the cache if the chunk of data already is stored in the cache;
the chunk of data is added to the cache dependent on the detected frequency of occurrence of the chunk of data in the computerized system and dependent on another attribute of the chunk of data;
the other attribute of the chunk of data is an access attribute;
the other attribute of the chunk of data is an access attribute referring to one or more of a frequency and a recency of access to the chunk of data in the computerized system;
a predicate is determined on the frequency of occurrence and on the access attribute, and the chunk of data is added to the cache if an output of the predicate is true, and the chunk of data is not added to the cache if an output of the predicate is false;
a weighing function is determined for the frequency of occurrence and on the access attribute, and a result of the weighing function is compared to a result of the weighing function for a frequency of occurrence and an access attribute of another chunk of data, and the chunk of data is added to the cache dependent on the an output of the comparison;
the other chunk of data is one or more of a chunk of data competing with the chunk of data for inclusion into the cache and a chunk of data identified for a future removal from the cache;
an identifier is determined for the chunk of data for detecting its frequency of occurrence in the computerized system;
the identifier is a hash value for the chunk of data;
the identifier is determined only if the access attribute fulfills a criterion;
the identifier is determined only if one or more of a frequency and a recency of access to the chunk of data exceeds a threshold.

According to a further aspect of the present invention, a computer program product is provided comprising a non-transitory computer readable medium having computer readable program code embodied therewith, the computer readable program code comprising computer readable program code configured to perform a method according to any one of the preceding embodiments when executed on a processing unit.

According to another aspect of the present invention, a computerized system is provided comprising a solid state memory and a controller adapted to use said solid state memory as a cache for the computerized system, wherein the controller is adapted to add a chunk of data to the cache dependent on a detected frequency of occurrence of the chunk of data in the computerized system.

According to another aspect of the present invention, a computerized system is provided comprising a solid state memory and a controller adapted to use the solid state memory as a cache for the computerized system, wherein the controller is adapted to remove a chunk of data from the cache dependent on a detected frequency of occurrence of the chunk of data in the computerized system.

Preferred embodiments of the systems contain one or more of the following features:
the controller is adapted to add the chunk of data in addition dependent on an access attribute of the chunk of data;
the controller is adapted to add the chunk of data dependent on one or more of a frequency and a recency of access to the chunk of data in the computerized system;
a data structure is comprised for chunks of data having an access attribute and a detected frequency of occurrence assigned to each chunk of data in the data structure, wherein the controller is adapted to add the chunk of data to the cache subject to the access attribute and subject to the frequency of occurrence for the chunk of data as recorded in the data structure.

Embodiments described in relation to the methods shall also be considered as embodiments disclosed in connection with any of the other categories such as the systems, the computer program product, etc., and vice versa.

### BRIEF DESCRIPTION OF THE SEVERAL VIEWS OF THE DRAWINGS

FIG. 1 is a block diagram of a computerized system according to an embodiment of the present invention.

FIG. 2 is a caching scheme for caching duplicate copies of data blocks according to an embodiment of the present invention.

FIG. 3 is a flow chart of a method for operating a solid state memory as a cache according to an embodiment of the present invention.

FIG. 4 is a flow chart of a method for operating a solid state memory as a cache according to another embodiment of the present invention.

FIG. 5 is a flow chart of a method for operating a solid state memory as a cache according to a further embodiment of the present invention.

FIG. 6 is a block diagram of a computerized system according to another embodiment of the present invention.

FIG. 7 is a block diagram of a computerized system according to a further embodiment of the present invention.

### DETAILED DESCRIPTION

As an introduction to the following description, described is a general aspect of the invention, concerning a computerized system and a method for operating a solid state memory, in particular as a cache in a computerized system.

A solid-state memory in general, and a solid state drive (SSD) in particular, comprise a rewritable non-volatile memory which uses electronic circuitry such as NAND flash memory for storing data. Given that solid state memories offer exceptional bandwidth resulting in high throughput as well as excellent random I/O (input/output) performance resulting in low latency along with an appreciated robustness due to lack of moveable parts, they may be considered as a preferred cache medium.

Solid state memories may be characterized in that data can be stored therein in units. A unit may be an entity in the solid state memory device for writing data to and reading data from. Multiple such units may form a block. A block may be defined as a set of multiple units. In some solid state memory devices, a block denotes the smallest entity for an erasure operation, which includes that the data of all units of a block may only be erased altogether.

The following disclosure uses terminology of flash technology, although it is understood that any such disclosure shall be applicable to other solid state memory technologies as well, such as DRAM, Phase-Change Memory or any other type of storage that can be used to support the cache. Specifically, in NAND flash technology units are denoted as pages, multiples of which units form a block. Hence, read and write operations can be applied to pages as a smallest unit of such operation, and erase operations can only be applied to entire blocks. And while in other storage technologies outdated data can simply be overwritten by new data, flash technology requires an erase operation before new data can be written to an erased block. For the reason that in flash technology erase operations take longer than read or write operations and can be carried out only at a block granularity, a writing technique, called “write out of place”, is applied in which new or updated data is written to some free page offered by a free page allocator instead of writing it to the same page where the outdated data resides. The page containing the outdated data is invalidated in this process.

At some point in time, a process called “garbage collection” performed by a software, hardware of firmware entity denoted as garbage collector, frees blocks for new writes by selecting a block from a set of blocks holding data and moving the content of all valid pages of that block to free pages in different blocks. As a result, the subject block finally comprises invalid pages only and can be erased. While this procedure requires some additional write operations in excess, it is apparent that by such approach immediate as well as frequent erase operations are avoided, which would contribute to a much higher overall processing than an overhead of some additional write operations. A block reclamation scheme may be based on a cyclic buffer, a greedy window, a container marker scheme, or others.

On the other hand, a block may only be erased a limited number of times before it turns bad and becomes unusable. Therefore, the overall lifetime of an SSD may depend on the number of writes to it: The higher the rate of writes is, the higher the rate of block erasures will be and, thus, the shorter the lifetime of the device.

Summarizing, solid state memory typically is used in a log-structured way given that it is to be erased before it can be re-written. Writing a solid state memory in a log-structured way hides a high latency introduced by erase operations but leads to write amplification, i.e., a unit of actual user/host write may lead to more than one unit of actual memory write due to data relocation operations required upon garbage collection wherein garbage collection refers to the background process of reclaiming memory space occupied by invalid data by relocating valid data in that memory space to another place.

Preferably, a solid state memory is used as a cache for a storage system. The storage system may comprise one or more hard disk drives as storage media, or one or more optical disk drives, or one or more solid state drives, or a mix of such drives of different technology, and may represent a mass storage for an enterprise storage system, for a personal storage system, or for a web based (cloud) storage system, for example. An entity accessing such cache may be a host, and specifically the operating system of such host. The usage of a solid state memory as a cache in a computerized system may improve the performance of the computerized system. The computerized system may comprise at least the solid state memory and a controller therefore. In one embodiment the computerized system may additionally include the storage system and/or the host accessing the storage system via the solid state memory cache. The cache may physically be located at a location of the storage system, or at a location of the host, or at a location remote from the host and the storage system.

When one or more SSDs are used as a cache, a controller comprising cache management code logic may be running inside the SSD itself, or, alternatively may be embodied as a controller for an array of SSDs, or, alternatively may be embodied in a controller of a storage system comprising the SSDs and preferably multiple arrays of SSDs, or, alternatively may be embodied in a controller of a host system accessing the storage system. The SSDs may be organized in a single logical address space using RAID or any other scheme. Preferably, the solid state memory cache stores its data on the SSDs, while the metadata for the cache may be stored in a DRAM memory or on the SSDs themselves, along with the data.

In conventional caches, it is preferred not to store arbitrary data but only selected data because of the limited size of the cache. It is preferred to only store data in the cache that is accessed rather often. This data is also denoted as “hot” data in the context of caching. By admitting only data that has been classified as “hot” into the cache the rate of population writes to the cache can be significantly reduced, effectively allowing for a better read bandwidth. This approach is also denoted as selective caching.

In case the cache is a solid state memory, a smart approach as to the selection of data to be admitted/added/written to the cache also leads to a longer lifetime of the device in view of the write amplification in solid state devices. At the same time, a cache-hit ratio is increased due to a reduced cache pollution resulting in an increased system performance.

It is preferred to select a chunk of data to be added to the cache or to be removed from the cache dependent on a frequency of its occurrence in the computerized system. The higher the frequency of occurrence is, the better the subject chunk of data may be suited for inclusion in the cache. This approach is based on the insight that chunks of data that have a high frequent occurrence in the computerized system on the one hand seem to represent important data and at the same time can be cached without claiming lots of space in the cache memory given that for any appearance of such chunk of data in the computerized system a pointer to a single entry for this chunk of data in the cache is sufficient. This may result in a cache offering high performance and high capacity, which improves the performance of block-level storage systems.

A chunk of data in the context of the present invention may be any set of data containing two or more of smallest data entities such as bits. However, it is preferred that a chunk of data at least includes 1 Kbyte in order not to allow for too many chunks of data with multiple occurrences. Specifically, in case the solid state memory is organized in blocks, a chunk of data evaluated for its occurrence and subject thereto considered for caching may be of block size. In case the solid state memory is organized in pages contributing to a block, a chunk of data considered for caching may be of page size, too. In the following, blocks or pages may be used instead of chunks of data without limiting the scope of these embodiments.

One or more parameters for determining if a chunk of data is to be admitted to the cache is the detected frequency of occurrence of such chunk of data, which include any parameter equal to or derived from the frequency of occurrence. The occurrence frequency preferably is the occurrence in the computerized system which presently is detected. In one embodiment, the frequency of occurrence in the cache itself is critical. Hence, the occurrence in the computerized system here may be equivalent to the occurrence in the cache itself. Any chunk of data that is already present in the cache by at least one entry shows a higher frequency of occurrence than another chunk of data that either never has made it into the cache although being evaluated for admittance or has never been evaluated before for admittance to the cache. Therefore, the number of occurrences does not necessarily reflect the absolute number of occurrences of the chunk of data in the host system, but may, in one embodiment, only refer to the occurrences transparent to the cache which may also depend on the frequency of accesses to the subject data chunk. In some rare scenarios data chunks that are hardly ever accessed may never make it into the cache but at the same time may have a high frequency of occurrence without being visible to the cache in the computerized system. Hence, there may be limits in the detectability of an overall frequency of occurrence. Therefore, the presently detected frequency of occurrence is preferably used for the purpose of deciding whether to admit a chunk of data to the cache or not, which in some instances may differ from the absolute frequency of occurrence.

However, in other embodiments, the computerized system may also include one or more of the host and the storage system. Here, information may be available as to the frequency of occurrence of a chunk of data additionally in the host and/or the storage system. This information may then also be used for determining the frequency of occurrence of this data chunk.

By evaluating if the data chunk has duplicates in the computerized system, preferably an assessment is made as to the content of the data chunk. Whenever the data chunk appears in multiple duplicates its content is stored multiple times which may indicate a content that is more important than the content of a data chunk which only appears once or rarely in the computerized system. Hence, the present caching concept also is referred to as content aware caching and specifically refers to a cache that effectively solely holds de-duplicate data, that is, only keeps a single copy of blocks of data that have many duplicates. Thereby, an effective size of the cache becomes larger and a large number of write operations to the solid state memory cache can be avoided given that adding a duplicate chunk of data to the cache may be achieved solely by amending the cache metadata but does not require a write operation of the data chunk to the cache memory space itself.

In contrast to a data de-duplication effort applied to a memory space as such, the present method and system do not require such sort of compression technique for reducing the amount of data in the cache given that copies of already existing cache entries do not make it into the cache but only become registered in the cache metadata. Hence, embodiments of the present invention pertain to how the cache controller decides which data to add to the cache, and in a different aspect which data to evict from the cache when a replacement is required, preferably based on both the content frequency and access attributes of the data chunks investigated.

In a preferred embodiment, in addition to making the caching selection dependent on the frequency of occurrence in the computerized system, the caching selection is made dependent on an access attribute of the subject data chunk. Such access attribute may refer to an access frequency of such chunk of data in the computerized system, and in addition or alternatively may refer to an access recency of such chunk of data in the computerized system. Again, in a preferred embodiment the computerized system is represented by the cache system such that any access attributes can be determined from the user requests arriving at the cache.

Both parameters access frequency and recency may preferably be applied in common in the selection process, and one or both of the parameters or any mathematical combination thereof or any other logical access attributes and/or statistics representing an access attribute may also be denoted as temperature of a chunk of data. Hence, the more and/or the more recent accesses there are the hotter a data chunk is. It is preferred that the higher a temperature of a chunk of data is the higher its caching utility is. The caching utility may be understood as a measure referring to the suitability of a chunk of data to be introduced to the cache or to remain in the cache if already there. For instance, the access attribute of a chunk of data may be equal to a total number of read and write operations to that chunk of data for some period of time, or a weighted sum of sequential and random operations on the chunk of data, or depending on the physical medium on which the chunk of data is allocated. In a very preferred embodiment, the access attribute of the chunk of data is equal to the total number of user reads and writes to that chunk of data. The access attribute of a chunk of data with a Logical Block Address (LBA) x is denoted as h(x) in the following.

In this embodiment of the present invention, the caching concept combines an awareness of the content of the subject chunk of data with an access selective caching. Hence, the controller for the cache takes caching decisions not only based on the temperature of data but also on the frequency of their occurrence/content. In a preferred embodiment, the cache controller admits writing data chunks to the cache that have a high temperature and a high content frequency compared to other data chunks that exhibit less heat or less commonality. The approach of this embodiment stems from the observation that the caching utility of a logical block becomes higher as its access frequency and its content frequency become higher. For instance, if the controller for the cache were to choose between two candidate blocks that have the same access frequency, then the controller preferably chooses the block that has the higher content frequency, i.e., the higher frequency of occurrence in the cache. Since in this embodiment the caching is also made dependent on the frequency of occurrence, some of the recently accessed data will not be cached which is unusual for caching strategies based on access attributes. Hence, this is in contrast to traditional DRAM based caches that typically employ an LRU-based cache management algorithm.

In a preferred embodiment, the computerized system, and preferably the cache system itself maintains a data structure, also referred to as a watchlist that holds statistics of blocks that were recently accessed. Typically, the data itself is not stored in this data structure but a reference to said data is stored instead. Based on these statistics, the system will decide whether a block is one of sufficient caching utility to be cached. In this watchlist, access statistics in form of access attributes is combined with content frequency statistics for the various blocks. When deciding about a cache population with one or more candidate blocks, it is preferred that both the access attribute and the content frequency of the candidate block/s found in the watchlist are taken into account. It is preferred that this watchlist is maintained by the cache controller given that the cache controller is in charge for responding to access requests. It is preferred, that a data chunk in the watchlist is identified by its logical block address (LBA), and the access attribute and the content frequency are linked to the subject LBA.

In another embodiment, the watchlist, and potentially the cache management itself is not based on the logical addresses of cached data, but only on their content. This may entail that instead of being organized around logical block addresses, the watchlist and the cache would be organized around the fingerprints/identifiers of cached content.

In a preferred embodiment, a subroutine is applied which serves the determination if the content of a block is identical to the content of a different block and as such for the determination of the frequency of occurrence of such block. For this purpose, an identifier is determined and assigned to a block. Such identifier is also denoted as a fingerprint in the following, and specifically may be a hash value of the block. It is preferred, that in such de-duplication mechanism a unique fingerprint is assigned to each block containing the identical data. In order to determine if two or more blocks are of identical content, the identifiers of the two or more logical blocks are compared which implies that first the identifiers for these blocks are determined. As a result of the comparison of the identifiers the system can determine whether the content is the same or not. However, it is not required that the cache itself performs this subroutine. The cache at least is provided a mechanism to find out the fingerprints of blocks. This mechanism may be local to the cache or be implemented via communication with a different system.

In a preferred embodiment, for a content frequency higher than 1, a write to the cache SSD may not be required at all, if one of the duplicates of the block has already been cached.

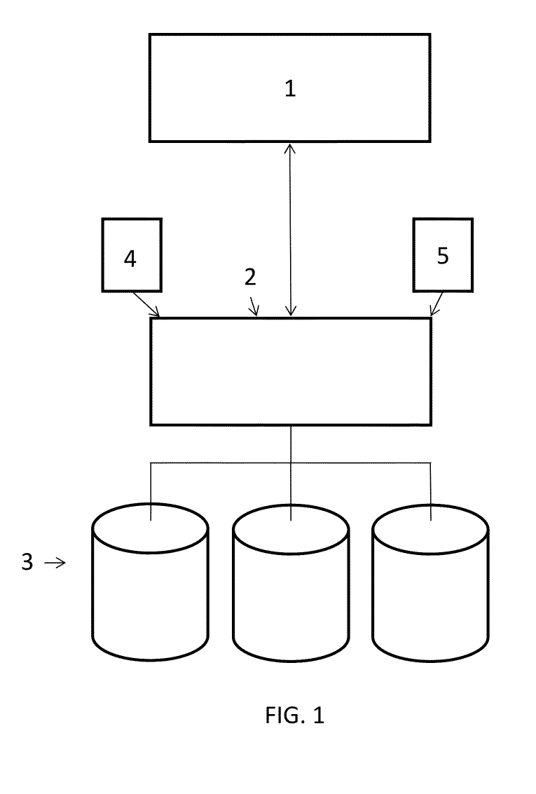

FIG. 1 illustrates a computerized system according to an embodiment of the present invention. It comprises a storage system 3 which in the present figure is indicated as an array of hard disk drives (HDD). A host computer 1 may require access to the storage system 3 for reading and/or writing data. In between the host computer 1 and the storage system 3 there is arranged a solid state memory 2 in form of a flash memory. The solid state memory 2 is used as a cache for temporarily storing data that have one or more duplicates and preferably that are frequently accessed for reading and/or writing from or to the storage system 3. A controller for the cache operations is referred to as 4. A controller for managing the solid state memory 2 as such is referred to as 5.

The functions of the controllers 4 and 5 may, in different embodiments, be implemented by a common hardware processing unit, or may be addresses by individual processing units. The controllers 4, 5 may each or commonly reside at a location of the solid state memory 2 or elsewhere. The solid state memory 2 may be arranged at the location of the storage system 3 or at the location of the host 1.

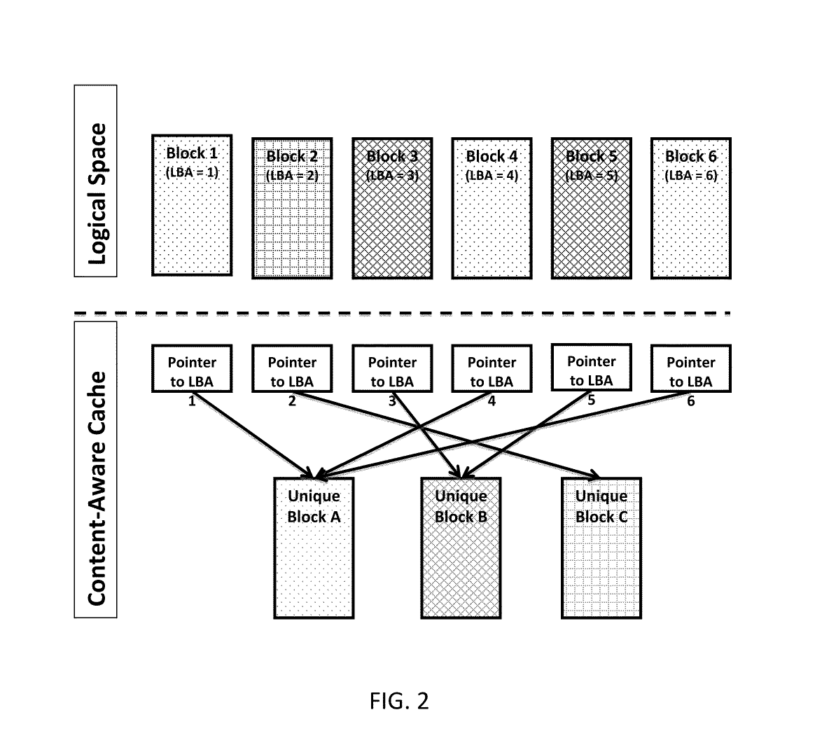

In the caching scheme of FIG. 2 for caching duplicate copies of data blocks according to an embodiment of the present invention, the caching of blocks of data relies on the frequency of occurrence, i.e., the frequency of the content of the data in said block. The frequency of occurrence of a block is, for example, defined as the total number of blocks in the computerized system, that are duplicates of that block. The frequency of occurrence of a block with LBA address x is denoted as d(x). For instance, if blocks x, y, and z have the same content, and provided no other block in the computerized system has that content, then d(x)=d(y)=d(z)=3. For any block u with unique content, d(u)=1. A de-duplication method according to an embodiment of the present invention would only store a single copy of the block on the caching storage medium. The cache then only has pointers in its metadata for each one of the corresponding LBA addresses to the contents of the block. An example is shown in FIG. 2. Blocks 1, 4 and 6 contain the same data A. Blocks 3 and 5 contain the same data B. Only block 2 contains data C which is unique data within this set of blocks.

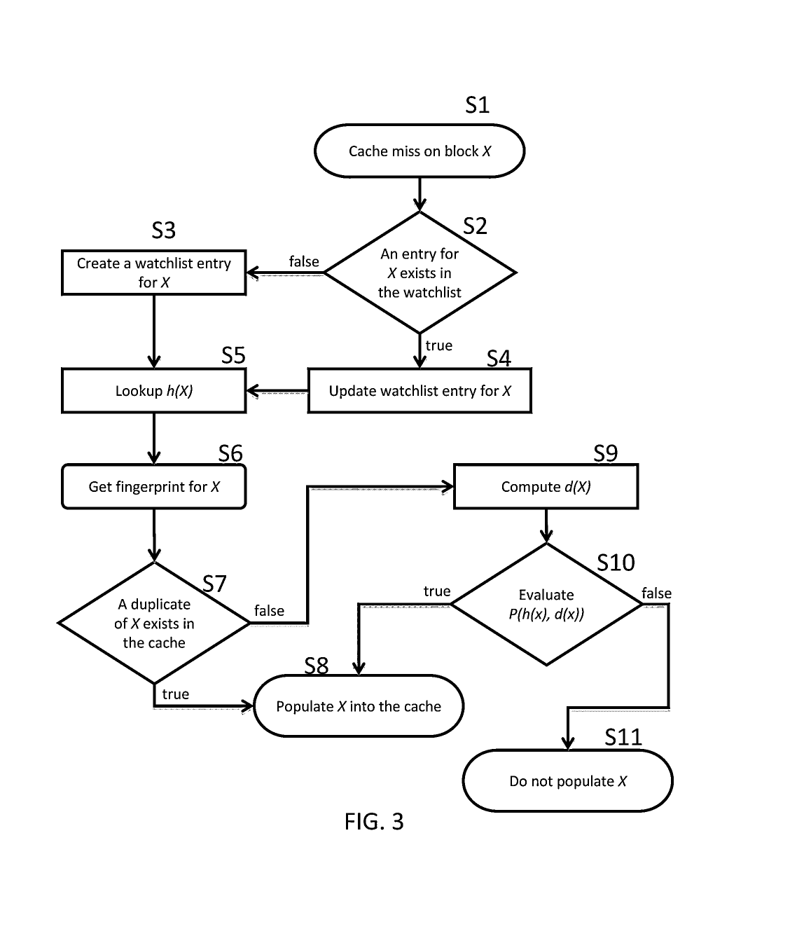

FIG. 3 illustrates a flowchart representing a method according to an embodiment of the present invention. It is assumed that a host issues a read or a write request for reading data from or to writing data to a storage system, e.g. an array of HDDs. The overall data to be written comprises multiple blocks of data, of which only a single block X is considered in the present scheme. However, the same routine may be applied to any block of the data to be read or written.

In step S1 it is verified that presently there is no entry for block X in the cache. In step S2, it is verified if watchlist/data structure for supporting the content selective caching comprises an entry for the block X. If this is not the case (false), a new entry is created in the watchlist for block X in step S3. In case the watchlist already comprises an entry for block X (true), this entry is updated in step S4, e.g., its access statistics is updated as is its content statistics. For example, in case the watchlist assigns a frequency of occurrence and a frequency of access to block X, these attributes are updated in the watchlist.

In any case, in step S5 the present access frequency h(X) of block X is determined. In subsequent step S6 the identifier/fingerprint for the data of block X is determined, e.g., by means of calculation, which result in turn is used in step S7 for determining if a duplicate of block X exists in the cache. If such duplicate exists (true), block X is added to the cache in step S8, without writing the data of block X to the cache. Instead, it is added in the metadata for the cache pointing to the already existing entry for the block with the same data. In case there is no duplicate of block X in the cache (false) the content/occurrence frequency d(X) for block X is determined in step S9. In step S10, a heuristic predicate function P (h(X), d(X)) is determined which takes the access frequency h( ) and the content/occurrence frequency d( ) of the block X as input and returns as output whether the block should be cached (true) in step S8 or not (false) in step S11. Typically, h( ) and d( ) can be implemented by using a lookup operation via an index structure, such as a hash table that is maintained by the watchlist. Hence, in the present method, if a duplicate of an incoming block is already cached, then the incoming block is always admitted to the cache, as this does not entail any cost for the system: No space is allocated in the cache and no data is written to the cache. Instead, only the cache metadata will be updated.

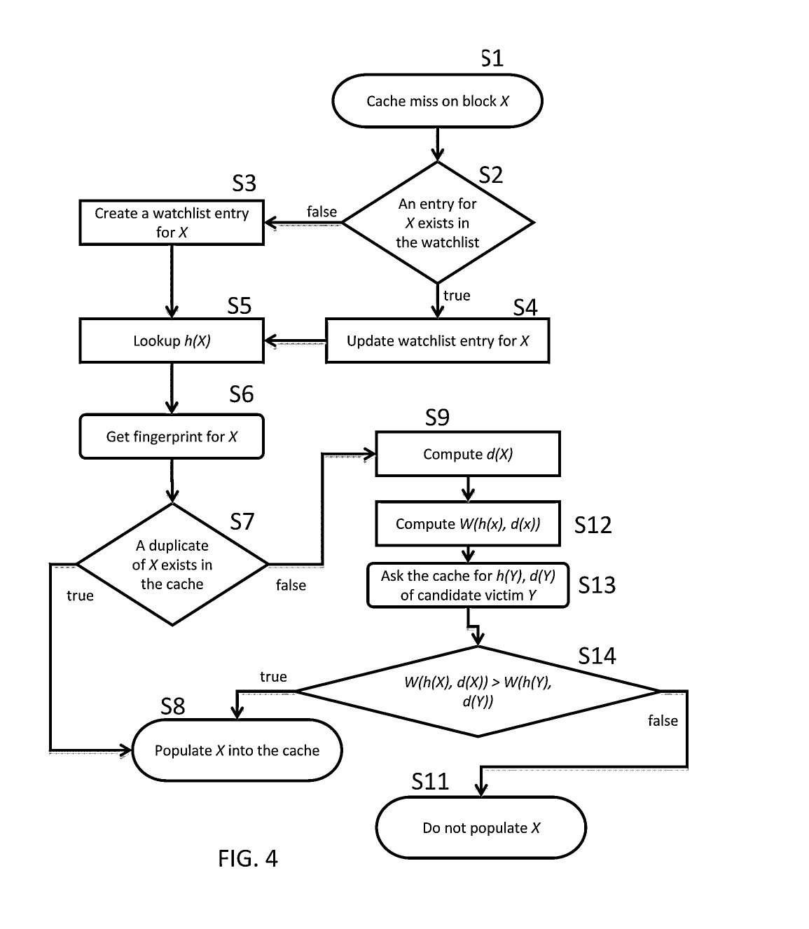

FIG. 4 illustrates a flowchart representing a method according to another embodiment of the present invention. In this embodiment, the cache population logic is coordinated with a cache replacement algorithm according to which blocks of data are determined that will be evicted from the cache. Hence, the population decisions are preferably made adaptive to the characteristics of the cached content.

In such a case, the predicate P( ) will depend on the current state of the cache. It is preferred that the system compares the access attribute and the content frequency of a candidate block for population against the access attribute and the content frequency of a block in the cache that is a candidate for replacement, in view of when the cache is occupied, an existing cached block is to be replaced in order to make room for a new block.

In the present embodiment, the steps S1 to S9 are known from the method of FIG. 3, and the result of the verification step S7 is the same, i.e., the block X is added to the cache in step S8 in case a duplicate of block X already can be found in the cache (true). Or, if no such duplicate exists (false), in step S9 the content frequency d(X) of block X is calculated before in step S12 a weighing function W(h(X), d(X)) is determined dependent on the access attribute d(X) and the content frequency h(X). In step S13, which step could be implemented at any other point in time, the access frequency d(Y) and the content frequency h(Y) of another block Y are determined, which block Y is a candidate block for eviction from the cache. The weighing function W( ) here represents a measure of a caching utility of a block. When comparing the caching utility of the two blocks X and Y it is preferred that such heuristic weighting function W( ) on h( ) and d( ) is applied, as in step S14. Whenever it turns out that the caching utility W(X) of block X requesting entry into the cache exceeds the caching utility W(Y) of the block Y being a candidate for eviction from the cache (true), the block X will be added to the cache while the block Y will be removed from the cache. On the other hand, whenever the caching utility W(Y) of the block Y to be evicted exceeds the caching utility W(X) of the block X requesting to be added to the cache (false), the utility of block Y still is valued more than the utility of the block X such that, in step S11, block X will not be added to the cache while block Y remains in the cache, possibly until another block with a higher caching utility W( ) is determined for insertion into the cache. It is preferred that in such a case the system utilizes an interface between the cache population logic and the cache management in order for the cache management to inform the cache population logic about the attributes of the next candidate for eviction.

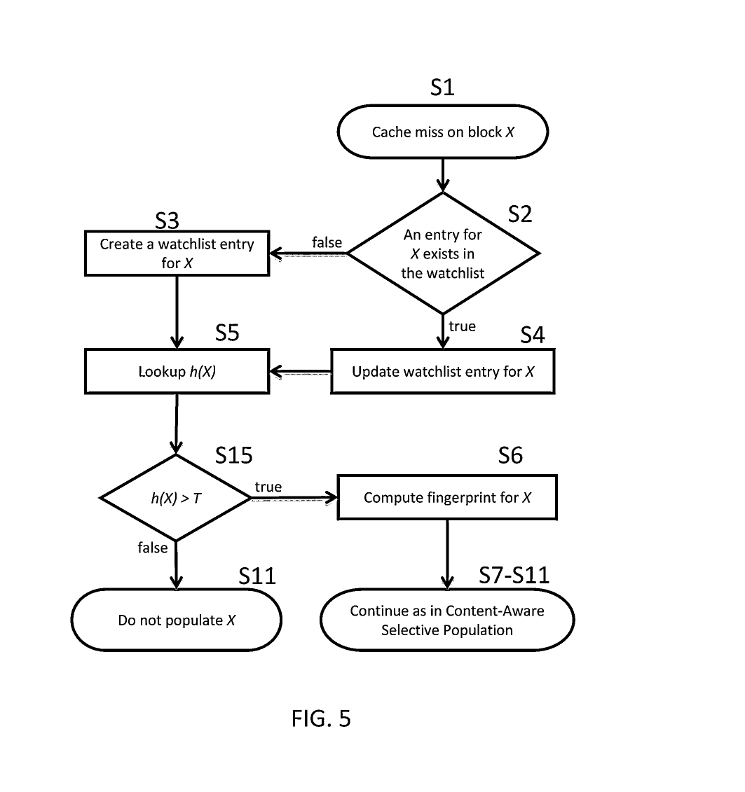

FIG. 5 illustrates a flowchart representing a method according to another embodiment of the present invention. The methods presented previously make the implicit assumption that the system computes the fingerprint of all incoming data in order to decide whether a chunk of data should be cached or not. However, since computing the fingerprint may preferably rely on a cryptographically secure hashing algorithm in order to minimize the probability of hashing collisions, the computational overhead of computing the fingerprint may in some instances not be negligible. In the method according to the proposed embodiment, which is also denoted as “access-aware selective de-duplication”, the overhead of computing fingerprints is minimized by only computing the fingerprints of the blocks that have a high probability to be admitted into the cache. The intuition is that if the access frequency of a block is high, then de-duplicating it will probably be worth the effort, as there is a high probability that the block will be admitted to the cache. Hence, a threshold access frequency is set for a block to enter the cache. Hence, the main idea of this embodiment is that before computing the fingerprint of the incoming data—wherein steps S1 to 55 are identical to the method of FIG. 3—the system will compare the access frequency h(X) of the block X against a threshold T in step S15. If the access frequency h(X) is above the threshold T (true), then the system will proceed with determining the fingerprint for this block X as illustrated in FIG. 1, or alternatively as illustrated in FIG. 4. On the other hand, if the access frequency h(X) of block X is below or equal to the threshold T, the caching procedure will be stopped and block X does not find its way into the cache. The threshold T may be a static threshold, or may be a dynamic threshold.

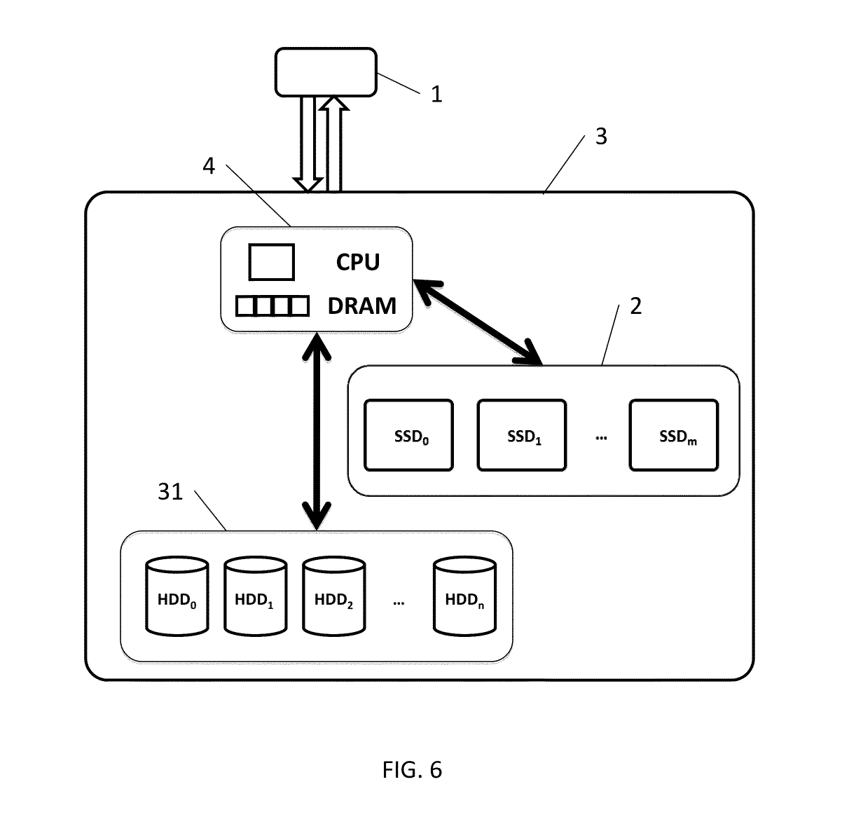

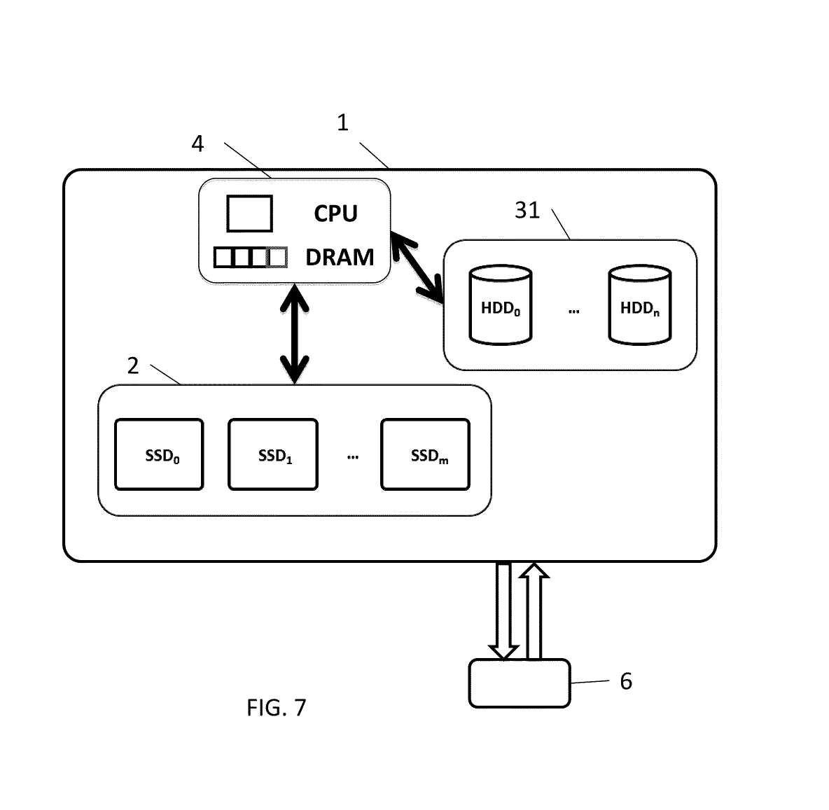

The proposed invention is applicable to multiple storage system architectures including but not limited to the architectures shown in FIG. 6 and FIG. 7. FIG. 6 shows a computerized system in which a host 1 is connected to a storage system 3. The solid state memory cache 2 in form of an array of SSDs is part of the storage system 3 and is controlled by a storage controller 4 which in additionally assumes the cache control. The controller 4 is equipped with a DRAM memory, and a CPU, of course. The backend medium for storing data is an array 31 of HDDs. One or more of the SSDs are used as a caching layer between the DRAM cache of the controller 4 and the array 31 of HDDs as backend of a storage system. This computerized system may specifically contain a flash cache in or related to a storage controller of a Storage-Area Network (SAN).

FIG. 7 in turn shows a block diagram of a different embodiment of a computerized system. Here, a host server 1 is equipped with one or more direct-attached SSDs and uses the SSDs as a cache 2 between the server's main memory in form of DRAM and the storage in form of an array 31 of HDDs that is direct-attached to the server, or is accessed over a SAN network (e.g., by means of a storage controller connected to the host via a Fibre-Channel network). This computerized system may hence specifically be a host-based flash cache on a direct-attached SSD.

The proposed invention assumes a system that preferably uses a block-level cache to speed up accesses to a backend storage. Preferably, the cache stores its data on flash-based SSDs, while the backend storage will be an HDD-based storage system in a preferred embodiment. In such a computerized system, it can be efficient to identify which data to store in the cache so as to improve the effective capacity of the cache, the performance of the cache as well as the endurance of the flash-based SSDs on which the caching is done.

As will be appreciated by one skilled in the art, aspects of the present invention may be embodied as a system, method or computer program product. Accordingly, aspects of the present invention, in particular in form of the controller, may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for operating a solid state memory as a cache in a computerized system, the method comprising one or more of:
adding a chunk of data to the cache based on a detected frequency of occurrence of the chunk of data in the computerized system; and
removing the chunk of data from the cache based on the detected frequency of occurrence of the chunk of data in the computerized system.

2. The method according to claim 1, wherein the chunk of data is added to the cache by updating a metadata structure for the cache if the chunk of data already is stored in the cache.

3. The method according to claim 1, wherein the chunk of data is added to the cache based on the detected frequency of occurrence of the chunk of data in the computerized system and based on an additional attribute of the chunk of data.

4. The method according to claim 3, wherein the additional attribute of the chunk of data is an access attribute referring to one or more of a frequency and a recency of access to the chunk of data in the computerized system.

5. The method according to claim 4, further comprising:
determining a predicate for one or more of the frequency of occurrence and the access attribute; and adding the chunk of data to the cache only if an output of the predicate is true.

6. The method according to claim 4, further comprising:
determining a first result of a weighing function for the frequency of occurrence and for the access attribute;
comparing the first result of the weighing function to a second result of the weighing function for a frequency of occurrence and an access attribute of another chunk of data; and
adding the chunk of data to the cache based on an output of the comparison.

7. The method according to claim 6, wherein the other chunk of data is one or more of a chunk of data competing with the chunk of data for inclusion into the cache and a chunk of data identified for a future removal from the cache.

8. The method according to claim 1, further comprising determining an identifier for the chunk of data for detecting a frequency of occurrence of the chunk of data in the computerized system, wherein the identifier is a hash value for the chunk of data.

9. The method according to claim 8, wherein the identifier is determined based on one or more access attributes of the chunk of data exceeding a threshold.

10. A system, comprising:
a solid state memory;
a controller adapted to use the solid state memory as a cache for the computerized system,
wherein the controller is adapted to perform one or more of:
adding a chunk of data to the cache based on a detected frequency of occurrence of the chunk of data in the computerized system; and
removing a chunk of data from the cache based on a detected frequency of occurrence of the chunk of data in the computerized system.

11. The computerized system according to claim 10, wherein the controller is additionally adapted to add the chunk of data based on an access attribute of the chunk of data, the access attribute comprising one or more of a frequency and a recency of access to the chunk of data in the computerized system.

12. The computerized system according to claim 11, comprising a data structure for chunks of data having an access attribute and a detected frequency of occurrence assigned to each chunk of data in the data structure,
wherein the controller is adapted to add the chunk of data to the cache subject to the access attribute and subject to the frequency of occurrence of the chunk of data as recorded in the data structure.

13. A computer program product comprising a non-transitory computer readable medium having computer readable program code embodied therewith, the computer readable program code comprising computer readable program code configured to perform a method for operating a solid state memory as a cache in a computerized system, the method comprising any one or more of:
adding, by a processor, a chunk of data to the cache based on a detected frequency of occurrence of the chunk of data in the computerized system; and
removing, by the processor, the chunk of data from the cache based on the detected frequency of occurrence of the chunk of data in the computerized system.

14. The computer program product of claim 13, wherein the chunk of data is added, by the processor, to the cache by updating a metadata structure for the cache based on the chunk of data already being stored in the cache.

15. The non-transitory computer program product of claim 13, wherein the chunk of data is added, by the processor, to the cache based on the detected frequency of occurrence of the chunk of data in the computerized system and based on an additional attribute of the chunk of data.

16. The computer program product of claim 15, wherein the additional attribute of the chunk of data is an access attribute referring to one or more of a frequency and a recency of access to the chunk of data in the computerized system.

17. The non-transitory computer program product of claim 13, wherein the method further comprises:
determining, by the processor, a predicate for one or more of the frequency of occurrence and the access attribute; and adding the chunk of data to the cache only if an output of the predicate is true.

18. The computer program product of claim 16, wherein the method further comprises:
determining, by the processor, a first result of a weighing function for the frequency of occurrence and for the access attribute;
comparing, by the processor, the first result of the weighing function to a second result of the weighing function for a frequency of occurrence and an access attribute of another chunk of data; and
adding, by the processor, the chunk of data to the cache based on an output of the comparison.

19. The computer program product of claim 18, wherein the other chunk of data is one or more of a chunk of data competing with the chunk of data for inclusion into the cache and a chunk of data identified for a future removal from the cache.

20. The computer program product of claim 13, further comprising determining, by the processor, an identifier for the chunk of data for detecting a frequency of occurrence of the chunk of data in the computerized system, wherein the identifier is a hash value for the chunk of data.
